(19) United States
(12) Patent Application Publication
(10) Pub. No.: US 2011/0154741 A1
(43) Pub. Date: Jun. 30, 2011

(54) INTERLOCK FOR SWING-OUT DOOR

(75) Inventor: Andreas Pellegrini, Edermunde (DE)

(73) Assignee: GEBR. BODE GMBH & CO. KG, Kassel (DE)

(21) Appl. No.: 12/935,750

(22) PCT Filed: Mar. 31, 2009
(86) PCT No.: PCT/EP2009/053785

§ 371 Date: Dec. 21, 2010

(30) Foreign Application Priority Data
Apr. 1, 2008 (DE) 20 2008 004 518.5

(51) Int. Cl. B60J 5/04; E05B 65/20

(52) U.S. Cl. 49/501

(57) ABSTRACT

The invention relates to a door system for a public transit vehicle, comprising a door (2) and a door portal (1), wherein the door (2) is moved substantially parallel to the exterior vehicle wall when the door is opened and closed and wherein the door (2) comprises a vertical math closing edge (31) in front in the direction of closing, said edge abutting a main portal edge (32) running vertically in the door portal (1) in the closed position of the door (2), and a secondary closing edge (33) behind in the direction of closing, said secondary closing edge abutting a secondary portal edge (34) running vertically in the door portal (1) in the closed position of the door (2). The main closing edge (31) moves along an s-shaped path of motion (10) when opening and closing takes place and the secondary closing edge (33) moves along a circular path of motion (10). At least one locking bolt (4) is provided at the main closing edge (31), said locking bolt engaging into a counter support (3) located at the main portal edge (32). At least one first closure element (36) is located at the secondary closure edge (33), said first closure element cooperating with a second closure element (38) located at the secondary portal edge (34) and sealing the door (2).

### TECHNICAL FIELD

The invention relates to a door system for a short and long-distance public transport vehicle, comprising a door and a door portal, wherein the door, during opening and closing, is moved substantially parallel to the outer vehicle wall and the door comprises a vertically extending primary closing edge disposed to the front in the closing direction and abutting, in the closed state of the door, against a primary portal edge extending vertically in the door portal, and comprises a secondary closing edge disposed to the rear in the closing direction and abutting, in the closed state of the door, against a secondary portal edge extending vertically in the door portal, wherein the primary closing edge is moved along an s-shaped trajectory and the secondary closing edge is moved along an arc-shaped trajectory during opening and closing.

### BACKGROUND

In the area of city and intercity buses, outward-swinging doors are known in which the contact force against the door seal has to be provided by means of the drive for the opening and closing mechanism. If the door closes, the door is moved parallel to the longitudinal vehicle axis, pressed against the door portal and locked, for example by means of a double-pivot gear. The force with which the door has to be pressed against the seal in order for the seal to take effect is in this case provided by means of the drive for the opening and closing mechanism. It is not until the door seal has reached its predetermined compression that an interlocking mechanism possibly becomes effective. Alternatively, the door may also be retained in the closed position by the contact force of the drive alone. This requires a comparatively strong drive because an unfavorable lever arm is effective in particular when the door seal is being compressed. A pressure loss in hydraulic or pneumatic systems causes a lack of contact force, so that wind noise is generated and, in a worst case scenario, the door can be pushed open during transit by a person leaning against it.

In the case of rail vehicles and short and long-distance public transport vehicles, the door is usually displaced, after abutting in the door portal, in the Z-direction, that is, vertically relative to the surface of the road. In the process, a locking wedge on the door is respectively pushed into a locking wedge in the door portal and presses the door into the sealing system. Preferably, two wedge pairs are in this case respectively provided on each door edge. This system requires large forces in order to push the door into the locked position. The kinematic system of the door has to effect both a pivoting movement as well as a lifting movement. In the case of hydraulic or pneumatic systems, there is the additional problem that the interlock becomes ineffective in the case of pressure loss in the system, and that the door may inadvertently fall open partially or even completely. This may also happen in the case of mechanical gear units if they are not self-locking and if the contact force has to be provided actively by means of the engine.

### BRIEF SUMMARY OF THE INVENTION

The invention provides a secure interlock of a door in the door portal of a vehicle, wherein the closed door is supposed to have a large degree of comfort with regard to noise. For this purpose, the door is supposed to abut against the seal so firmly that no or only little wind noise is generated and the door itself does not produce any noise, for example by rattling, even at higher speeds. Small forces are supposed to be required for closing and the mechanism concerned is supposed to have a simple structure.

According to the invention, a generic door system is provided, wherein at least one retention bolt latching into a counter support disposed on the primary portal edge is provided on the primary closing edge, and wherein at least one closure element cooperating with a second closure element disposed on the secondary portal edge and closing the door is disposed on the secondary closing edge. The present invention provides an advantageous interlock that can be actuated by means of the sequence of movements provided by the kinematic system of the door. Preferably, eight interlocking members are allocated to a door in a door portal. This means that two retention bolts are provided on the primary closing edge of the door, and two counter supports are provided on the primary portal edge, and two first closure elements are provided on the secondary closing edge and two second closure elements are provided on the secondary portal edge. The interlocking units secure the door in the door portal in such a way that it is firmly pressed against the door portal and into the seal disposed thereon. The seal thus effectively seals the vehicle even in the case of transverse acceleration and strong wind forces. For reasons of an advantageous load distribution, the interlocking members are disposed in the vicinity of the corners on the vertical edges of the door portal or the door.

The door can be opened and closed again by means of a kinematic system of the door. The kinematic system of the door can be configured in various ways. In one embodiment, slide bolts are attached to the door which are guided in slideways on the vehicle. The door can be moved along the slideway by means of a hydraulic, pneumatic or electro-mechanical actuating system. The kinematic system of the door may also be a gear unit controlled by a hydraulic, pneumatic or electro-mechanical actuating system. In this case, a gear unit comprises an arrangement of two pivoting arms which are rotated about an axis and move the door for opening and closing it. On their axes of rotation, the pivoting arms are driven for example by means of a hydraulic or pneumatic rotary drive or a hydraulic or pneumatic cylinder drive. Alternatively, an electro-mechanical actuating system can be provided. Combinations of a kinematic system of the door with slideways and pivoting arms are also possible.

Means for providing the s-shaped sequence of movements on the primary closing edge and the arc-shaped sequence of movements on the secondary closing edge required for locking the door system are provided in the kinematic system of the door; these means can be configured as gear systems or comprise guiding elements.

Closing direction denotes the direction in which the door is closed by means of the kinematic system of the door. The movement is substantially parallel to the outer wall of the vehicle.

At least one retention bolt is disposed on the primary closing edge of the door; at least one corresponding counter support is disposed on the primary portal edge. The counter support comprises a cutout into which the retention bolt on the primary closing edge latches at the end of the s-shaped closing movement of the door. The counter support then retains the retention bolt in a secured position which can only be released by swinging the door open on the primary closing edge. It was found that is advantageous to provide two retention bolts on the secondary closing edge and two associated counter supports on the secondary portal edge. Whether the retention supports are disposed on the door and the counter supports on the door portal, or the retention supports are disposed on the door portal and the counter supports on the door is immaterial.

At least one first closure element cooperating with a second closure element on the secondary door edge is disposed on the secondary closing edge. The closure elements become effective when the secondary closing edge of the door is pivoted in at the end of the arc-shaped trajectory. In order to open the door, the closure elements must be unlocked. Preferably, two first closure elements are provided on the secondary closing edge and two second closure elements are provided on the secondary portal edge, so that two closure means secure the secondary closing edge to the secondary portal edge. In this case, the closure elements can be configured, for example, as a rotary-latch lock or sliding-bolt lock and corresponding bolt, or as a latch lock with at least one corresponding latch retainer.

The closure elements on the secondary closing edge or the secondary portal edge can comprise a preliminary and a main latching position. Preliminary latching position denotes a position in which the door is secured but not firmly locked. The main latching position is the position in which the door is secured and firmly locked in the door portal.

The bolt merely has to latch into a recess on the sliding-bolt lock and locked. A sliding-bolt lock in this case denotes a lock in which at least one component with a recess can be displaced in a substantially transverse direction in order to secure the bolt. The closing process can also be actively supported by the sliding-bolt lock by the door being pulled in the closing direction by means of a suitable actuating system.

A rotary-latch lock denotes a lock in which a bolt is guided into a rotatably mounted rotary latch with a cutout. During this movement, the rotary latch is rotated and arrested. It is also conceivable that the rotary-latch lock actively supports the door portal being pulled in on the primary closing edge, for example by the rotary latch being pulled closed by means of a Bowden cable articulated on the rotary-latch lock.

In the embodiment of the closure as a latch with a corresponding latch retainer, the latch is biased and comprises a bevel at its tip which is suitable to press the latch in against the biasing force on a corresponding counter support during the closing process, and to then have it latch into a counter support. In a similar fashion, this is known from interlocks for conventional front doors.

The second closure element can be fixed on a support disposed on the door portal. This support can be an adjustable block, with the term adjustable meaning that the support can be adjusted by being displaced in the door portal using suitable means, such as elongated holes and screws guided by these elongated holes. This is necessary in order to be able to compensate for manufacturing tolerances of the door portal and/or the door. In this way, the closure can be adjusted such that on the one hand, a sufficient compression of the door seal system is ensured, and on the other hand, that the door is not impeded on its trajectory.

The closure can be released by means of an actuating device. Actuating device denotes an actuating system that can be hydraulic, pneumatic or electro-mechanical. Optionally, it acts on the closure elements by means of a linkage system, so that they can be unlocked so as to release the door automatically, or in the case of an emergency release, manually.

An emergency release requires that the closure be released and the door swung open without the kinematic system and the drive being able to impede the swinging movement. For this purpose, the closure should be released in the case of an embodiment of the closure as a rotary latch. If the closure is configured as a sliding-bolt lock, the latter should become freely moveable. If the closure is configured as a latch latching into a latch retainer, the latch should be pulled out of the latch retainer. The closures can be unlocked, for example, on all closures at the same time by means of a single linkage system operated by an actuating device in the normal case of automatic unlatching. Alternatively, the closures can be operated directly by means of a Bowden cable.

It must then be ensured that the door is moveable by hand. Irrespective of whether the kinematic system of the door comprises slideways and corresponding slide bolts or a pivot gear unit, it must be ensured that the kinematic system of the door is not self-locking and that the door can be moved against the actuating system of the door. In the case of hydraulic or pneumatic systems, the pressure can be released and the hydraulic actuator moved by means of a valve, in the case of electro-mechanical drives, a gear reduction should not be self-locking.

In the closed state of the door, the kinematic system of the door should require as little construction space as possible. In the closed state, a door gear unit assembled from pivoting arms lies parallel to the longitudinal vehicle axis. Though a large force can be provided in the longitudinal vehicle axis on the joint between the pivoting arm and the door in that state, only a small force can be provided transversely to the longitudinal vehicle axis. It is precisely close to this state of the closed door that the largest force is required during closing, namely for pressing the door against the seal. It is therefore proposed to support kinematic system of the door mechanically in pressing the door against the seal. Support means that not only do the levers of the kinematic system participate in completing the opening and closing trajectories on the door portal, but that additional support bearings become effective just before the door abuts against the door seal. The outward-facing flank of the retention bolt on the primary closing edge and the inward-facing flank of the counter support act as additional support bearings. The actuating system actuates the kinematic system of the door such that a large force in the longitudinal vehicle axis is produced during closing. This is deflected in the support bearing comprising the retention bolt and the counter support, which becomes additionally effective, so that the door seal can be firmly compressed.

### BRIEF DESCRIPTION OF THE DRAWINGS

Other advantages of the invention are shown in the following descriptions of the Figures. In the drawings:

FIG. 1: shows a door portal and a door in a sectional view from above,

FIG. 2: shows an area of a vehicle with a door portal and a door located therein in a closed state, comprising a primary closing edge and a secondary closing edge,

FIG. 3: shows the vehicle from FIG. 2 with an open door, with the trajectories associated therewith, which are completed when the door is opened and closed,

FIG. 4: shows a door portal and a door in a sectional view from above, wherein the door portal is interrupted by a parting line,

FIG. 5: shows a sectional view of an area from FIG. 4 illustrating an interlocking device and a device for opening the interlocking device.

### DETAILED DESCRIPTION

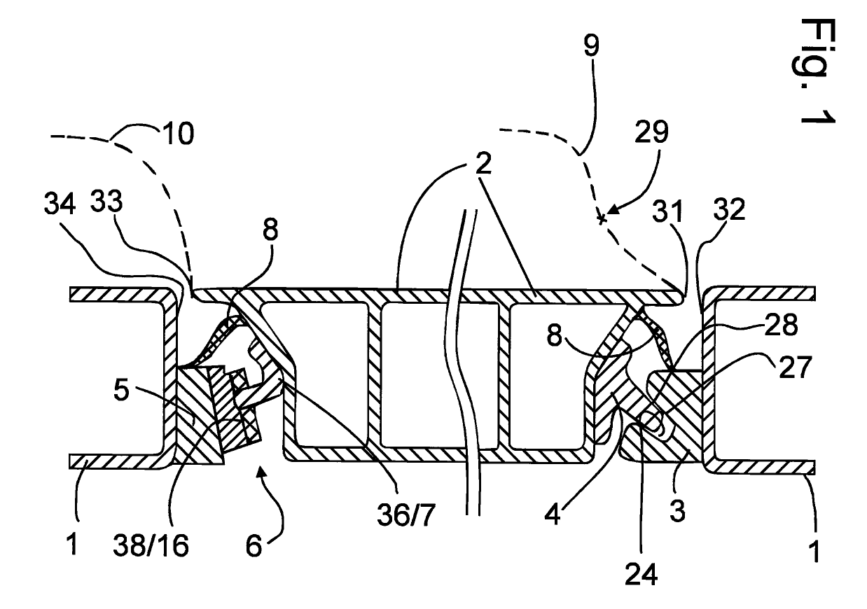

FIG. 1 shows a door portal 1 with a door 2 located therein comprising a primary closing edge 31 and a secondary closing edge 33. A first trajectory 9 is shown in dashed lines on the primary closing edge 31, a second trajectory 10 is shown on the secondary closing edge 33. The primary and secondary closing edges 31, 33 are guided along the trajectories 9, 10 during opening and closing. The primary closing edge 31 is located on the door 2 to the front in the closing direction, the secondary closing edge 33 is located on the door 2 to the rear in the closing direction. The primary and secondary closing edges 31, 33 are the vertically extending edges of the door 2. The primary closing edge 31, in the closed position of the door 2, directly abuts against a vertically extending primary portal edge 32, and the secondary closing edge 33 of the door 2 directly abuts against a secondary portal edge 34.

The door 2 is in the closed position, with the seals 8 abutting against their associated support surfaces on the support 5 on the secondary portal edge 33 and on a surface of a counter support 3. A retention bolt 4 is shown on the primary closing edge 31 in a cutout 24 in a counter support 3. A first trajectory 9 shows the movement that the primary closing edge 31 executes during the closing and opening of the door 2 in order for the retention bolts 4 on the primary closing edge 31 to be able to latch into the counter supports 3 on the primary portal edge 32. In this case, it is important that the first trajectory 9, in contrast to the second trajectory 10, has a point of inflection 29. What is decisive in this case is that, after the sequence of movements on the retention bolt 4 and the counter support 3 has been completed, the first closure element 36, here configured as a bolt 7, latches into a second closure element, in this case a lock 16, and the closure 6 becomes effective. For example, a rotary-latch lock or a sliding-bolt lock are conceivable as the lock 16.

It is possible that, when the door 2 is being closed, the retention bolts 4, on their outward-facing retention bolt edge 28, first come to rest on the inward-facing counter support edges 27. Additional points of support are thus created. During the further closing process, the kinematic system of the door pushes the door 2 against these additional points of support. Due to the configuration of the cutout 24, a force directed towards the inside of the vehicle is the result of a force applied on the retention bolt 4 against the counter support 3. The seal 8 can be compressed by means of this force pointing into the inside of the vehicle.

The closure 6 has to be released for opening the door 2, after which the secondary closing edge 33 moves along the second trajectory 10 for further opening the door. In order to adjust the lock 16 to the bolt 7, the position of the support 5 can be changed.

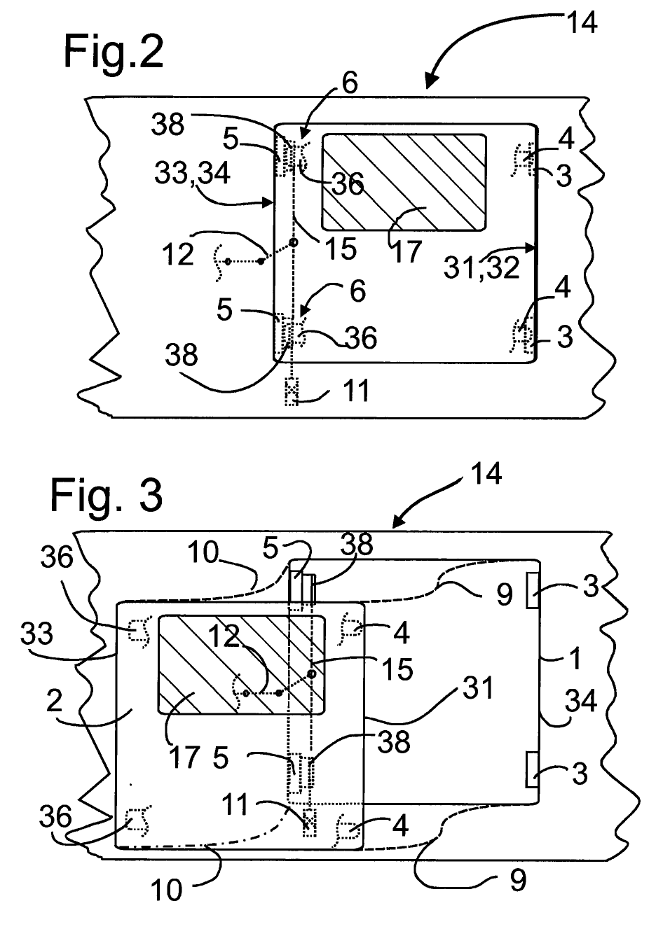

FIG. 2 shows an area of the vehicle 14 with the door portal 1 and the door 2 located therein with a window 17, with the door 2 being in its locked position. Two retention bolts 4 which are disposed on the primary closing edge 31 and latch into two corresponding counter supports 3 disposed on the primary portal edge 32 are shown in dashed lines. The embodiment comprising two retention bolts 4, respectively, and two counter supports 3, respectively, has proved advantageous. Two closures 6 including two first closure elements 36, respectively, and two second closure elements 38, respectively, which are respectively attached to a support 5, are also shown in dashed lines. This embodiment of two closures on the secondary closing edge 33 and the secondary portal edge 34 associated therewith has also proved advantageous. A linkage system 15 acts on the closures 6 via an actuating device 11 in order to release them.

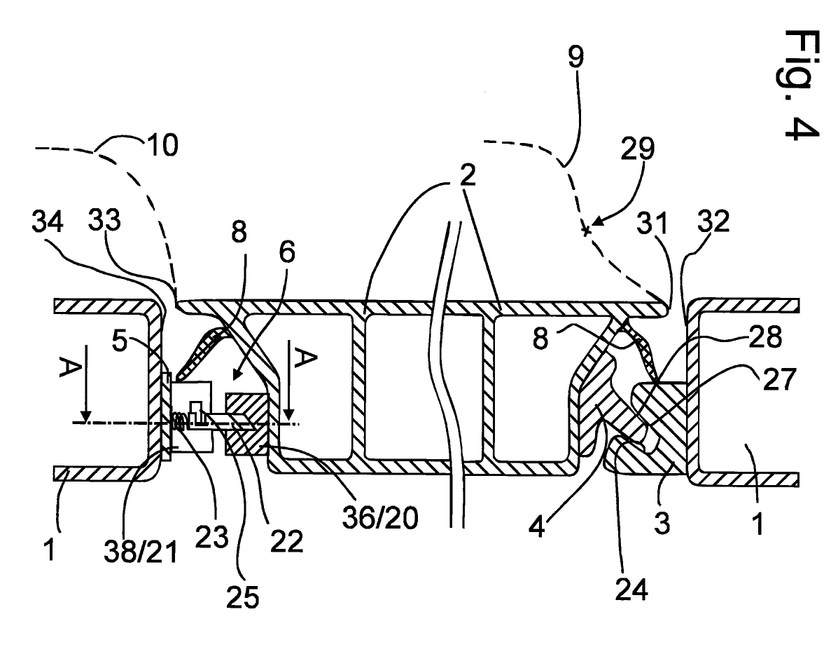

After the closures 6 have been released, the first closure elements 36 are out of engagement with the second closure elements 38, and the door 2 can move on the secondary closing edge 33 along the second trajectory 10 and on the primary closing edge 31 along the first trajectory 9, with the retention bolts 4 being pulled out from the cutouts 24 in the counter supports 3 due to the trajectory 9. The door 2 is thus opened and the state shown in FIG. 3 is produced.

A linkage system 15 does not only mean a rod but rather the devices by means of which the closures are released in a coupled manner when the actuating unit 11 is actuated. Thus, additional devices that are not shown may be disposed on the closures 6 that are associated with the linkage system 15. In the case of a large distance between the closures 6 on the secondary closing edge 33 and the secondary portal edge 34, and in the case of an embodiment of the linkage system 15 as a rod, it may be necessary to additionally dispose, between closures 6, a deflection mechanism 12 supporting the linkage system 15, so that it is not bent under the influence of the force occurring during the release of the closures 6. The linkage system 15 can be configured to be comparatively thin and thus lighter between the closures 6.

FIG. 3 shows the door portal 1 and the door 2 from FIG. 2 in the opened position. The first trajectory 9 and the second trajectory 10 are also shown.

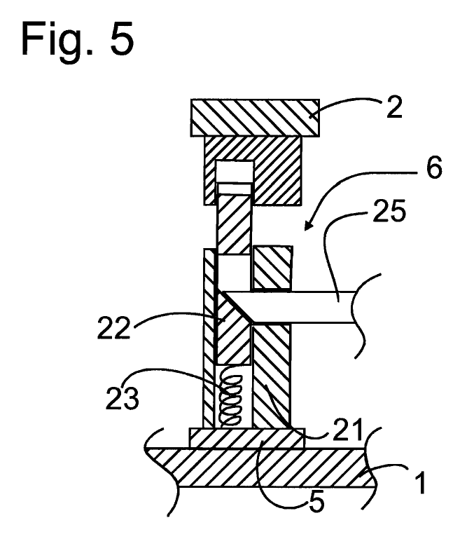

FIG. 4 shows a door portal 1 with a door 2 located therein in the closed position, in which the seals 8 are compressed and the retention bolt 4 is located in the counter support 3. The sequence of movements during opening and closing of the door 2 in this case is analogous to the sequence of movements described above. FIG. 4 shows a closure 6 which is configured differently from FIG. 1 and shown in a side view in FIG. 5. If the secondary closing edge 33 moves along the second trajectory 10 into its closed position, a latch 22 biased by means of a spring 23 is pressed in over the latch retainer 20 until the latch 22 reaches the cutout of the latch retainer 20 and snaps back. Once this has happened, the door 2 firmly abuts against the seal 8.

FIG. 5 shows a sectional view of the section marked “A” in FIG. 4. The Figure shows the latch 22 biased via the spring 23 and located in a latch guide 21, wherein the latch 22 can be pulled in via a shaped part 25 against the spring 23, whereby a release of the closure 6 can be effected. The shaped part 25 is actuated by means of the linkage system 15 controlled by the actuating device 11.

1.-6. (canceled)

7. Door system for a short and long-distance public transport vehicle, comprising:
a door and
a door portal, wherein the door, during opening and closing, is moved substantially parallel to the outer vehicle wall and wherein the door:
comprises a vertically extending primary closing edge disposed to the front in the closing direction and abutting, in the closed state of the door, against a primary portal edge extending vertically in the door portal, and
comprises a secondary closing edge disposed to the rear in the closing direction and abutting, in the closed state of the door, against a secondary portal edge extending vertically in the door portal, wherein the primary closing edge is moved along an s-shaped trajectory and the secondary closing edge is moved along an arc-shaped trajectory during opening and closing; and
at least one retention bolt latching into a counter support disposed on the primary portal edge is disposed on the primary closing edge, and at least one first closure element cooperating with a second closure element disposed on the secondary portal edge and closing the door is disposed on the secondary closing edge,
wherein the retention bolt, on its outward-facing side, comprises a retention bolt edge, which, during the closing process of the door, comes into contact with a counter support edge of the counter support, the edge facing in the direction of the inside of the vehicle, wherein the counter support edge acts as a point of support, so that a force directed towards the inside of the vehicle acts on the door.

8. Door system for a short and long-distance public transport vehicle according to claim 7, wherein, in the closure, the first closure element is a bolt and the second closure element is a sliding-bolt lock, wherein the bolt latches into the sliding-bolt lock.

9. Door system for a short and long-distance public transport vehicle the second closure element is a rotary-latch lock, wherein the bolt latches into the rotary-latch lock.

10. Door system for a short and long-distance public transport vehicle according to claim 7, wherein, in the closure, the first closure element is a latch counter support and the second closure element is a latch, wherein the latch latches into the latch counter support.

11. Door system for a short and long-distance public transport vehicle according to any one of the preceding claims, wherein the closure can be unlocked and locked by means of an actuating device via a linkage system and that the first closure element is brought out of and into engagement with the second closure element.

12. Door system for a short and long-distance public transport vehicle according to any one of the preceding claims, wherein the second closure element is mounted on a support which in turn is mounted on the secondary portal edge.
